(19) United States
(12) Patent Application Publication
(10) Pub. No.: US 2016/0165537 A1
(43) Pub. Date: Jun. 9, 2016

(54) PORTABLE TERMINAL DEVICE

(71) Applicant: Hitachi Maxell, Ltd., Ibaraki-shi, Osaka (JP)

(72) Inventors: Motoyuki SUZUKI, Ibaraki-shi (JP); Hideo NISHIJIMA, Ibaraki-shi (JP)

(21) Appl. No.: 14/906,586

(22) PCT Filed: Jul. 31, 2013
(86) PCT No.: PCT/JP2013/070689

§ 371 Date: Jan. 21, 2016

(51) Int. Cl. H04W 52/02; H04W 4/02; H04B 1/3883; H04W 4/22

(52) U.S. Cl. CPC H04W 52/028; H04W 4/22; H04W 4/02; H04B 1/3883; H04W 52/0225; H04W 88/02

(57) ABSTRACT

Provided is a portable terminal device capable of sustaining a battery remaining amount for an extended period of time, even in the event of an emergency such as a disaster. The present invention is provided with: a reception unit for receiving emergency disaster information; a positional-information acquisition unit for acquiring positional information; a storage unit in which preset positional information is stored; an electric power supply unit which supplies, to a plurality of parts configuring the portable terminal device, electric power supplied from a battery; and a control unit for controlling the electric power supply unit. When the emergency disaster information is received, the control unit controls the electric power supply unit on the basis of the positional information obtained by the positional-information acquisition unit and the positional information stored in the storage unit.

### TECHNICAL FIELD

The present invention relates to a portable terminal device.

### BACKGROUND ART

A device is conventionally known that transmits a safety confirmation e-mail for notifying a specific person specified in advance when a disaster occurred, when a specific operation has been performed for the device within a certain period of time after reception of an emergency disaster report, as described in Patent Literature 1, for example.

### CITATION LIST

### Patent Literature

Patent Literature 1: Japanese Patent Application Publication No. 2009-182395

### SUMMARY OF INVENTION

### Technical Solution

However, the above conventional technique has the following problems. In a case where terminals that have received the emergency disaster report transmit notifications such as e-mails notifying of the safety at the same time, network congestion or system down may occur. This causes a situation where outgoing calls are restricted and communication is difficult.

Further, a battery is depleted because of consecutive key operations by a user such as dialing in the situation where the communication is difficult, or because of waiting for recovery from the network congestion or the like while a cell phone terminal is left in a waiting state. In particular, in a case where the user has been affected by a disaster outside the user's home or a blackout has occurred in an area affected by the disaster, the battery cannot be charged. Therefore, a situation is caused where the user cannot perform communication because of the battery depletion when the user would like to perform communication.

In view of the above problems, the present invention provides a portable terminal device that can guarantee a battery remaining amount for a longer time even in an emergency such as a disaster.

### Solution to Problem

The summary of a typical one of inventions disclosed in the present application is briefly described below.
(1) A portable terminal device having a function of receiving emergency disaster information or blackout information and notifying a user, includes a receiver unit that receives the emergency disaster information or the blackout information, a positional-information acquisition unit that acquires positional information of the portable terminal device, a battery, and a power-source control unit that supplies electric power supplied from the battery to a plurality of parts forming the portable terminal device, and a control unit that controls the power-source control unit to control electric power consumption of the portable terminal device, wherein the control unit controls the power-source control unit based on the positional information acquired by the positional-information acquisition unit when the receiver unit has received the emergency disaster information or the blackout information.

### Advantageous Effects of Invention

According to the present invention, it is possible to provide a cell phone device that can guarantee a remaining amount of a battery for a longer time even in an emergency such as a disaster.

### BRIEF DESCRIPTION OF DRAWINGS

FIG. 1 is a block diagram showing a configuration example of a portable terminal device according to an embodiment of the present invention.

FIG. 2 is an example of a flowchart describing an operation of the portable terminal device.

FIG. 3 is an example of a flowchart of a communication process of the portable terminal device.

FIG. 4 is an example of a flowchart of an emergency receiving process of the portable terminal device.

FIG. 5 is an example of a flowchart of a positional-information acquisition process of the portable terminal device.

FIG. 6 is an example of a flowchart of a battery remaining amount confirming process of the portable terminal device.

FIG. 7 shows an example of settings of various items in an electric power saving mode.

FIG. 8 is a second example of the flowchart of the battery remaining amount confirming process of the portable terminal device.

FIG. 9 is a third example of the flowchart of the battery remaining amount confirming process of the portable terminal device.

FIG. 10 is a block diagram showing the second configuration example of the portable terminal device according to the embodiment of the present invention.

FIG. 11 shows an example of the settings of the various items in the electric power saving mode according to the second configuration example of the present invention.

### DESCRIPTION OF EMBODIMENTS

Examples of an embodiment are described below with reference to drawings.

### First Embodiment

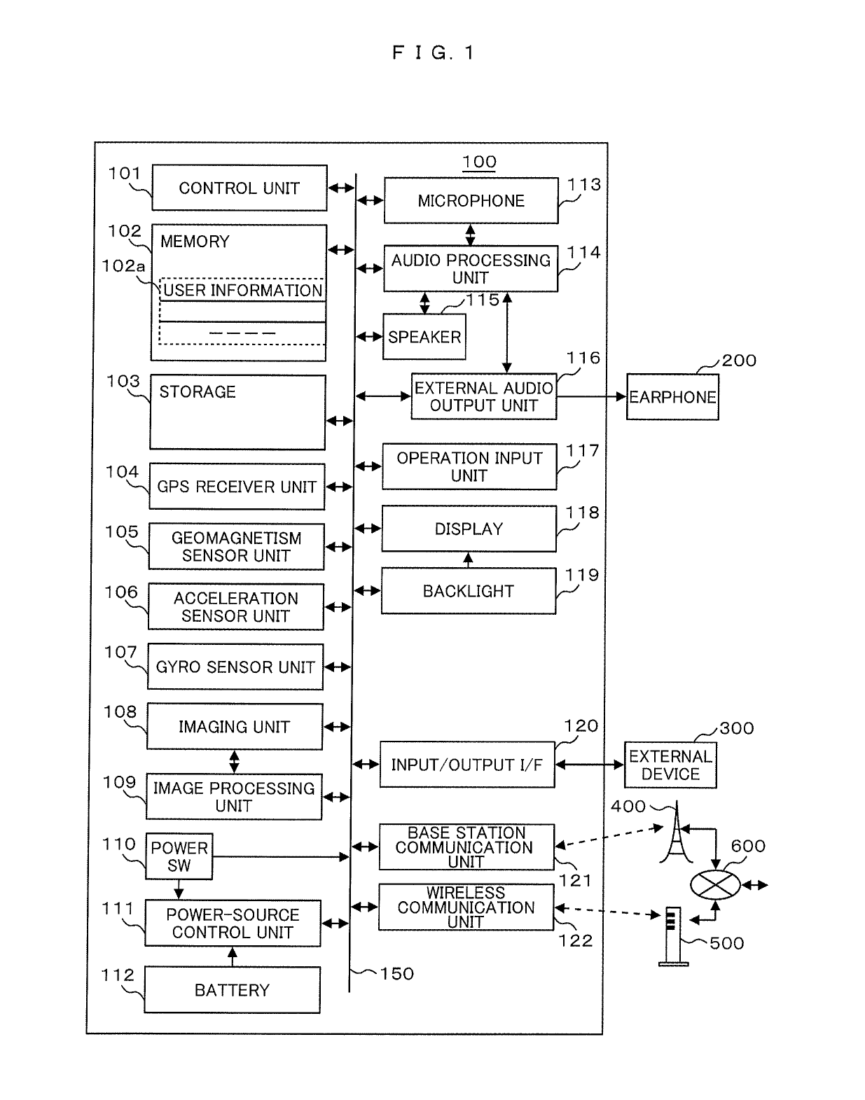

FIG. 1 is a block diagram showing an internal configuration example of a portable terminal device 100 according to an embodiment of the present invention.

An example in which the device 100 is a smartphone is described here. The portable terminal device 100 is configured by using a control unit 101, a memory 102, a storage 103, a GPS (Global Positioning System) receiver unit 104, a geomagnetism sensor unit 105, an acceleration sensor unit 106, a gyro sensor unit 107, an imaging unit 108, an image processing unit 109, a power switch 110, a power-source control unit 111, a battery 112, a microphone 113, an audio processing unit 114, a speaker 115, an external audio output unit 116, an operation input unit 117, a display 118, a backlight 119, an input/output I/F 120, a base station communication unit 121, and a wireless communication unit 122 as appropriate. Those are mutually connected via a bus 150.

The control unit 101 is configured by a CPU (Central Processing Unit) and the like. The control unit 101 executes a program stored in the memory 102 to control each of the components and perform various processes.

The memory 102 is a flash memory, for example, and stores a program and data used by the control unit 101. Data of user information such as a telephone number, an e-mail address to which an e-mail is to be transmitted in an emergency, and positional information of a user's home is stored in a predetermined region 102a of the memory 102. The portable terminal device 100 is further provided with the storage 103 such as a memory card. Also in the storage 103, data such as music, videos, and photos can be stored.

The GPS receiver unit 104 receives a signal from a GPS satellite in the sky. This enables detection of a current position of the portable terminal device 100. The geomagnetism sensor unit 105 is a sensor that detects a direction toward which the portable terminal device 100 faces. The acceleration sensor unit 106 is a sensor detecting an acceleration of the portable terminal device 100. The gyro sensor unit 107 is a sensor detecting an angular velocity of the portable terminal device 100. With these sensors, the inclination and the movement of the portable terminal device 100 can be detected in detail.

The imaging unit 108 is a camera, for example. A video displayed on the display 118 and a video input from the imaging unit 108 are processed in the image processing unit 109.

The microphone 113 inputs an audio in the outside thereto. The speaker 115 outputs an audio to the outside. The external audio output unit 116 outputs an audio while connected to an earphone 200, for example. The input/output audio is subjected to audio processing in the audio processing unit 114.

The operation input unit 117 is a touch-pad input device such as a capacitive touch pad, which detects a touch operation (hereinafter, referred to as a touch) by a finger, a touch pen, or the like, as an operation input. The display 118 is an LCD, for example, for displaying a video and an image and includes the operation input unit 117 in a display surface of the display 118. The backlight 119 controls the brightness of the display 118.

The input/output I/F 120 is a USB (Universal Serial Bus), for example, and is an interface that transmits/receives data to/from an external device 300.

The base station communication unit 121 is a communication interface that performs long-range wireless communication with a base station 400 for W-CDMA (Wideband Code Division Multiple Access) or GSM (registered trademark) (Global System for Mobile communications), for example. The wireless communication unit 122 is a communication interface that performs wireless communication with a wireless router 500 by a wireless LAN, such as IEEE802.11a/b/n. With these units, connection with an external network 600 via the base station 400 or the wireless router 500 is achieved, so that information can be transmitted/received.

The program or the data stored in the memory 102 or the storage 103 can be updated and added at any time by being downloaded from an external server (not shown) or the like through connection of the base station communication unit 121 or the wireless communication unit 122 with the external network 600 via the base station 400 or the wireless router 500. Also, data, a program, or the like can be updated and added through connection with the external device 300 such as a personal computer via the input/output I/F 120.

The power switch 110 is a switch that turns on and off the portable terminal device 100. When the power switch 110 has been pressed in a state where the portable terminal device is off, electric power supply from the power-source control unit 111 to each of the components is started. When the power switch has been pressed in a state where the portable terminal device 100 is on, the control unit 101 detects this pressing and controls the power-source control unit 111 to stop the electric power supply to each of the components. The battery 112 is a power source of the portable terminal device 100. The battery 112 supplies electric power to each of the components via a power line (not shown) after conversion to a voltage suitable for each of the components in the power-source control unit 111. The power-source control unit 111 is controlled by the control unit 101 to turn on and off the electric power supply to each of the components in accordance with an electric power saving setting. Further, the power-source control unit 111 monitors the state of the electric power supply from the battery 112, so that the power-source control unit 111 can detect a battery remaining amount.

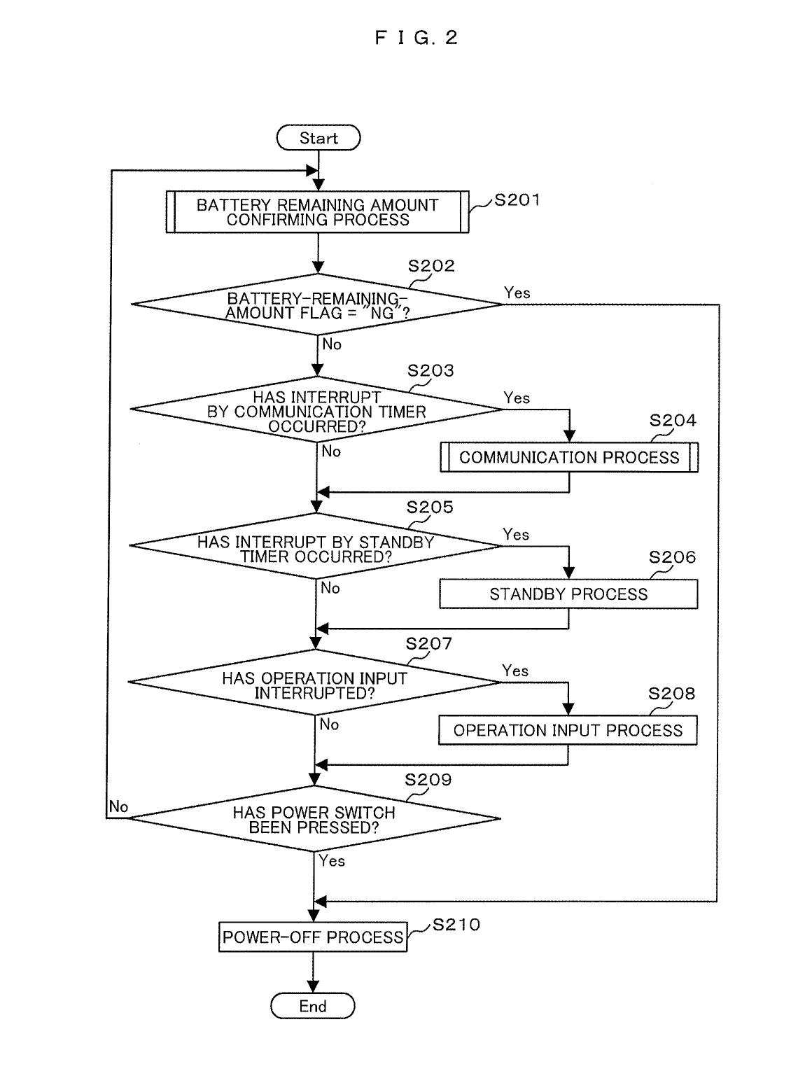

Next, an operation example of the control unit 101 of the portable terminal device 100 is described, with reference to a flowchart in FIG. 2.

In FIG. 2, a battery remaining amount confirming process that will be described later is performed first (S201). In a branch process S202, in a case where it has been determined from a battery-remaining-amount flag that no battery remaining amount is present (Yes), a power-off process S210 is performed and the process is ended. In a case where it has been determined that a battery remaining amount is present (No), it is then checked whether an interrupt has occurred by a timer for performing communication with the base station 400 or the wireless router 500 at a predetermined time interval Tw (S203). In a case where the interrupt has occurred (Yes), a process of communication with the base station 400 or the wireless router 500 is performed (S204). In S205, it is checked whether an interrupt by a standby timer has occurred. In a case where the interrupt has occurred (Yes), it is then determined that no operation input has been received in a predetermined period of time Ts or longer, and a standby process is performed in which the backlight 119 is turned off, for example (S206). In S207, it is checked whether an interrupt by an input from the operation input unit 117 has occurred. In a case where the interrupt has occurred (Yes), a process corresponding to the operation input is performed (S208). In S209, it is checked whether or not the power switch 110 has been pressed. In a case where the power switch 110 has been pressed (Yes), a power-off process is performed and the process is ended. In a case where the power switch 110 has not been pressed (No), the flow goes back to the process of the battery-remaining-amount confirming treatment S201, and the following processes are continued.

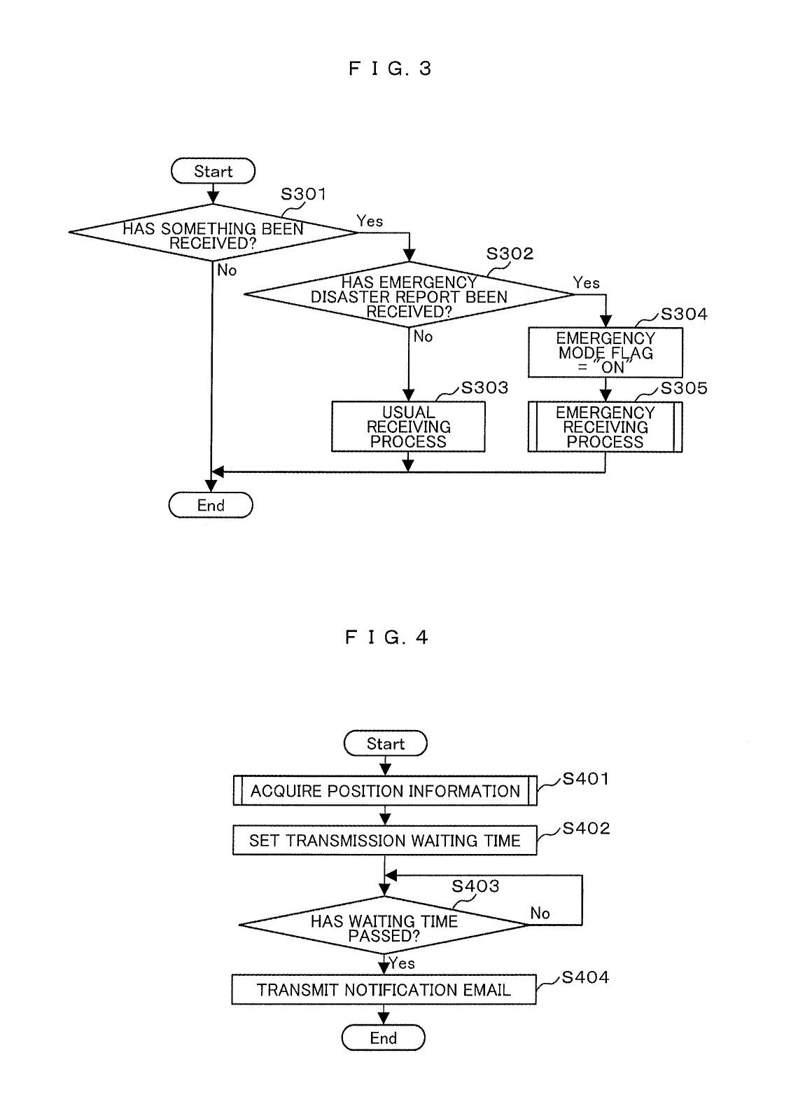

FIG. 3 shows an example of a flowchart of the communication process S204.

In FIG. 3, the base station communication unit 121 or the wireless communication unit 122 is operated first, to perform communication with the base station 400 or the wireless router 500 and check whether an e-mail or a call has been received (S301). In a case of no e-mail or call received (No), the process is ended. In a case where the e-mail or call has been received (Yes), it is then checked whether an emergency disaster report of an earthquake, a tsunami, or the like has been received (S302). In a case where the emergency disaster report has been received (Yes), an emergency mode flag is set to “ON” (S304), an emergency receiving process (S305) to be described later is performed, and the process is ended. In a case of no emergency disaster report received (No), a usual receiving process for an e-mail or a call is performed (S303) and the process is ended.

FIG. 4 shows an example of a flowchart of the emergency receiving process S305. In FIG. 4, a process of acquiring positional information of the portable terminal device 100 (S401) is performed first. Subsequently, a waiting time until the next transmission process is performed is set (S402). Here, the waiting time is set to prevent overflow of the processing in the base station from being caused by simultaneous transmission from a number of portable terminal devices that have received the emergency disaster report. For example, the waiting time is set to be different in accordance with the last digit of a telephone number given to the portable terminal device. It is checked in S403 whether or not the time set in S402 has passed. When the set waiting time has not passed (No), time measurement is continued. When the set time has passed (Yes), an e-mail including the content of the received emergency disaster report and the positional information acquired in S401 is transmitted to a preset destination (S404), and the process is ended. With the above process, it is possible to automatically transmit the positional information of the portable terminal device independently of an operation by the user even in a situation where the user forgets to operate the portable terminal device when being affected by the disaster.

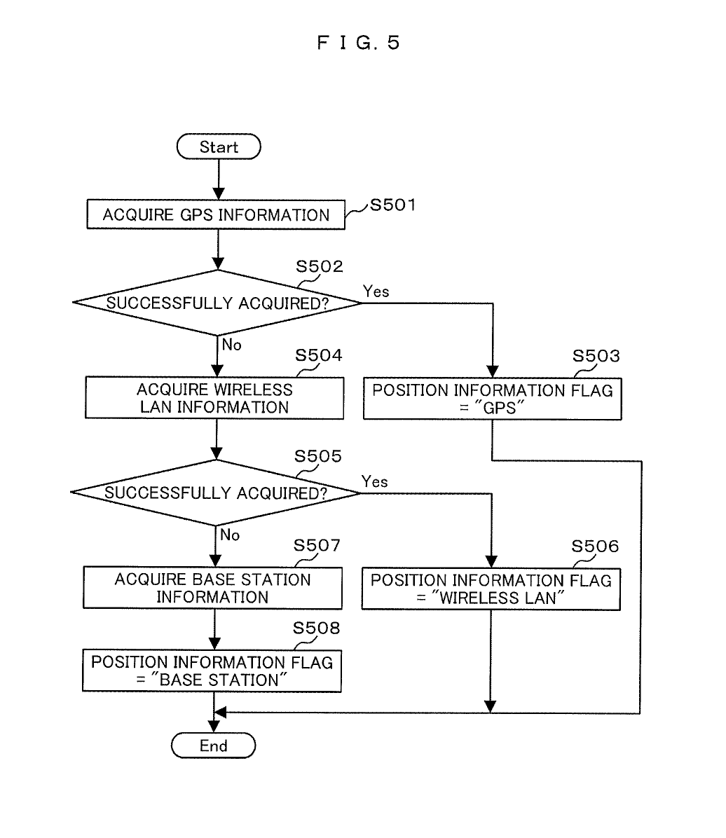

FIG. 5 shows an example of a flowchart of the positional-information acquisition process S401.

In FIG. 5, the GPS receiver unit 104 is operated first, to acquire positional information by GPS (S501). In a branch process S502, it is determined whether or not the positional information by GPS has been successfully acquired in S501. In a case of success (Yes), a positional-information flag is set to “GPS” (S503), and the process is ended. In a case where acquiring the positional information by GPS has failed (No), the wireless communication unit 121 is then operated to acquire positional information by the wireless LAN. In a branch process S505, it is determined whether or not the positional information by wireless LAN has been successfully acquired. In a case of success (Yes), the positional-information flag is set to “wireless LAN” (S506), and the process is ended. In a case where acquiring the positional information by wireless LAN has failed (No), the base station communication unit 120 is then operated to acquire positional information by the base station (S507), the positional-information flag is set to “base station” (S508), and the process is ended.

In general, the positional information acquired by GPS has better position accuracy than that acquired by the wireless LAN and the base station. However, the positional information by GPS cannot be acquired inside a building, for example. The above method uses a plurality of positional-information acquisition units, and it is therefore possible to surely acquire the positional information.

Further, the accuracy of the acquired positional information is different between the positional-information acquisition units. Therefore, when the content of the positional-information flag is transmitted in the notification e-mail transmission process S404, a range of searching the user can be estimated by checking the acquisition unit of the positional information transmitted from the portable terminal device of the user, in a case where it is impossible to contact the user of the portable terminal device who has been affected by a disaster, for example.

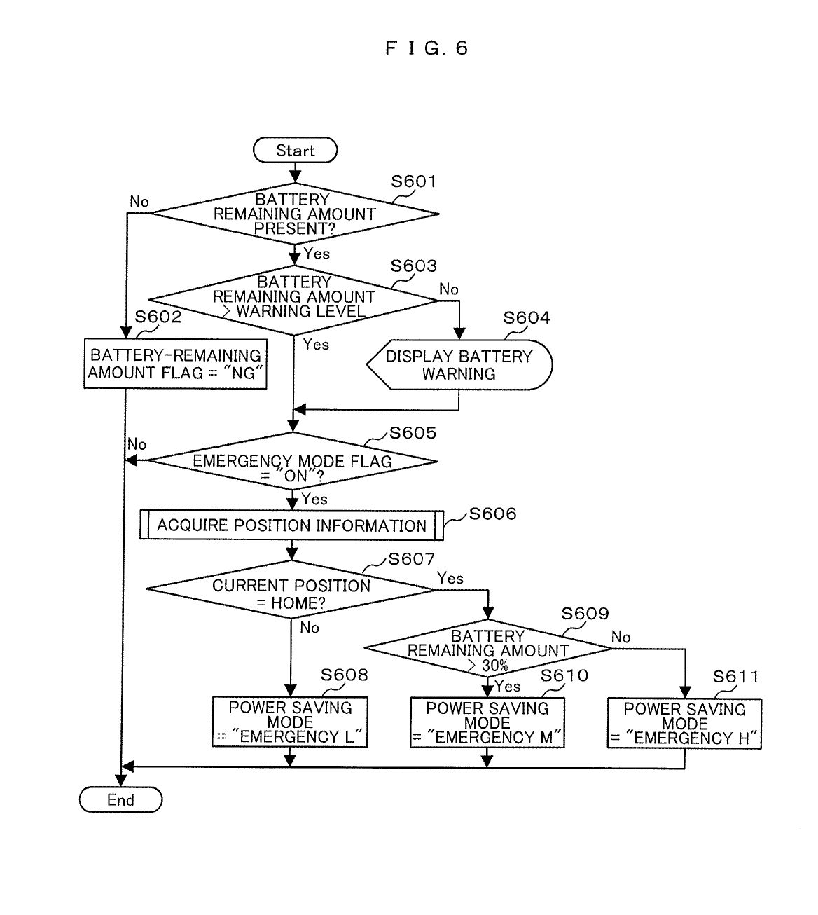

Next, FIG. 6 shows an example of a flowchart of the battery remaining amount confirming process S201.

In FIG. 6, it is first checked whether or not the battery remaining amount is present (S601). In a case of no battery remaining amount (No), the battery-remaining-amount flag is set to “NG” and the process is ended. In a case where it has been determined that the battery remaining amount is present (Yes), it is then checked whether or not the battery remaining amount is at a battery remaining amount warning level or higher (S603). In a case where the battery remaining amount is at the battery remaining amount warning level or lower (No), a warning that the battery remaining amount is low is displayed (S604) to urge the user to charge the battery. Subsequently, the emergency mode flag is checked (S605). When the flag is not “ON” (No), the process is ended. When the flag is “ON” (Yes), a positional-information acquisition process S606 that is the same as that in S401 is performed. It is checked whether or not the current position is the user's home from positional information acquired in the positional-information acquisition process S606 and positional information of the user's home stored as user information in advance in the memory 102a (S607).

The determination whether or not the current position is at the home is performed based on whether or not the distance from the position of the stored user's home to the current position is within a predetermined range (for example, 100 m). In a case where it has been determined that the current position is the user's home (Yes), the electric power saving mode is set to “emergency L” (S608) and the process is ended. In a case where it has been determined that the current position is not at the user's home (No), the flow branches to S609 where it is checked whether or not the battery remaining amount is a predetermined value (30% in this example) or more. In a case where the remaining amount of the battery is the predetermined value or less (No), the electric power saving mode is set to “emergency H” (S613), the setting of each of the components is changed so that the electric power consumption is the minimum, and the process is ended. In a case where the remaining amount of the battery is the predetermined value or higher (Yes), the electric power saving mode is set to “emergency M” (S612), and the process is ended.

By the above process, the setting in the electric power saving mode is changed in accordance with the positional information of the user's home stored as the user information, the current positional information, and the battery remaining amount when the emergency disaster report has been received.

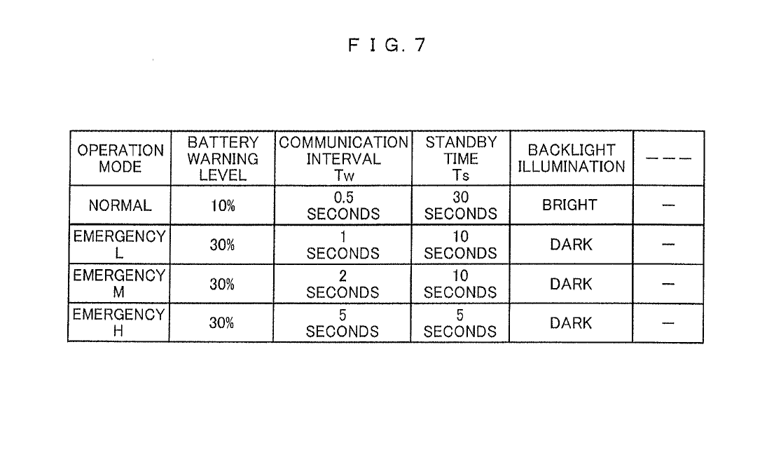

FIG. 7 shows an example of settings of various items in the electric power saving mode. For reducing the electric power consumed by the process of communication with the base station or the wireless router, the time interval Tw at which the communication process is performed is set to be longer by setting the electric power saving mode. Meanwhile, the standby time is set to be shorter so that transition to the standby state occurs promptly in a case of no operation. Further, it is highly likely that charging cannot be performed because of a blackout in an emergency, and it is impossible to expect when the blackout occurs. Therefore, in a case of emergency, the warning level of the battery remaining amount is set to be higher. With this setting, it is possible to issue the warning before the battery remaining amount is low, so that the user can charge the battery. Another setting, for example, setting backlight illumination to be dark, is performed. The above settings may be set by the user in an arbitrary manner.

By the above process, the electric power saving is enhanced in a place other than the user's home where it is highly likely that the charging is impossible, and the electric power consumption is set to the minimum when the battery remaining amount is the predetermined value or less. Therefore, the operation time of the portable terminal device can be extended.

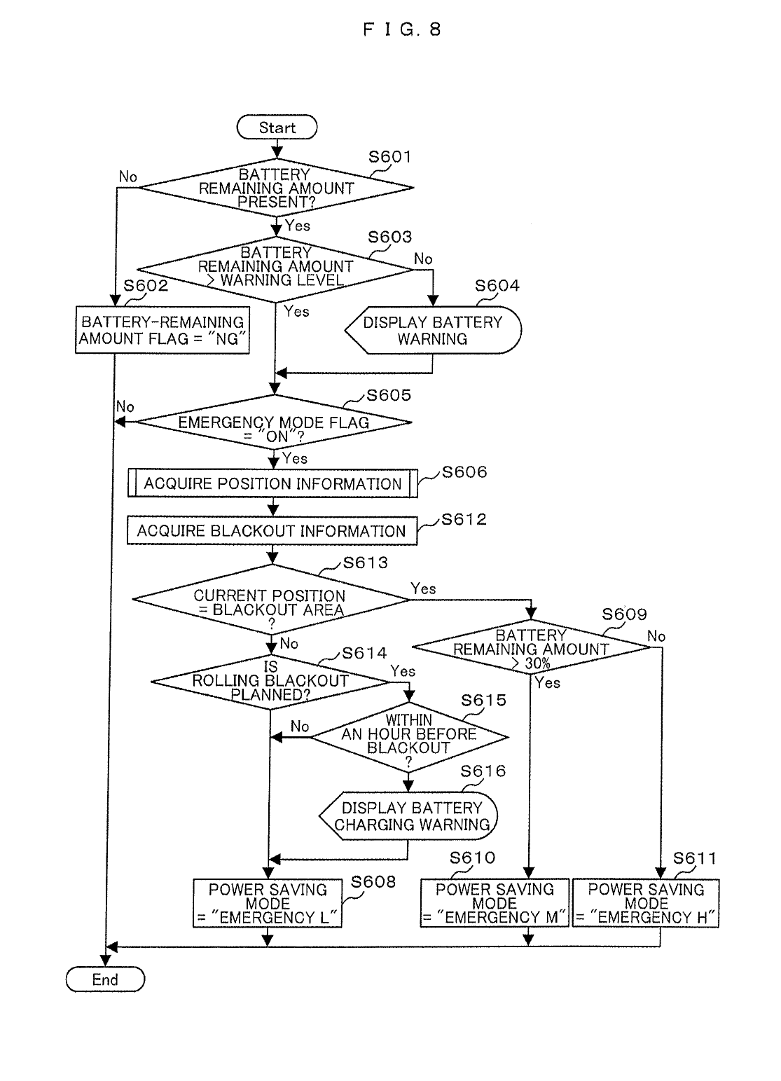

FIG. 8 shows the second example of the flowchart of the battery remaining amount confirming process S201.

The process in FIG. 8 is different from the battery remaining amount confirming process in FIG. 6 in that the branch process S607 based on the determination whether or not the current position is the user's home is replaced with processes from S612 to S616 using blackout information. The same processes as those in FIG. 6 are labeled with the same reference signs. Further, regarding portions of which the contents are the same as those in FIG. 6, those in FIG. 6 are incorporated and the description is omitted.

In FIG. 8, the same positional-information acquisition process as that in S401 is performed in S606. Subsequently, connection with the external network 600 via the base station 400 or the wireless router 500 is achieved, so that information on a blackout area or/and a blackout time is acquired, for example (S612). In a branch process S613, it is checked whether or not the current position is within the blackout area. When the current position is out of the blackout area (No), it is then checked whether a rolling blackout is planned (S614). When the rolling blackout is not planned (No), the electric power saving mode is set to “emergency L” (S608) and the process is ended. When the rolling blackout is planned (Yes), it is then checked whether or not the current time is a predetermined period of time (an hour in this example) before the rolling blackout (S615). When the current time is more than the predetermined period of time before the rolling blackout (No), the electric power saving mode is set to “emergency L” (S608) and the process is ended. When the current time is within the predetermined period of time before the rolling blackout (Yes), a display for promoting the charging of the battery is performed (S616), the electric power saving mode is set to “emergency L” (S608), and the process is ended. In the branch process S613, when the current position is within the blackout area (Yes), the flow branches to S609. In S609, it is checked whether or not the battery remaining amount is a predetermined value (30% in this example) or more. In a case where the remaining amount of the battery is the predetermined value or less (No), the electric power saving mode is set to “emergency H” (S611), each setting item is changed so that electric power consumption is the minimum, and the process is ended. In a case where the battery remaining amount is the predetermined value or higher (Yes), the electric power saving mode is set to “emergency M” (S610), and the process is ended.

By the above process, the electric power saving is enhanced when the current position is within the blackout area, because it is highly likely that the charging is impossible. Further, the electric power consumption is set to the minimum when the battery remaining amount is the predetermined value or less. Therefore, the operation time of the portable terminal device can be extended. Furthermore, the charging of the battery is promoted before the blackout based on the information on the rolling blackout. Therefore, it is possible to sufficiently charge the battery before the blackout.

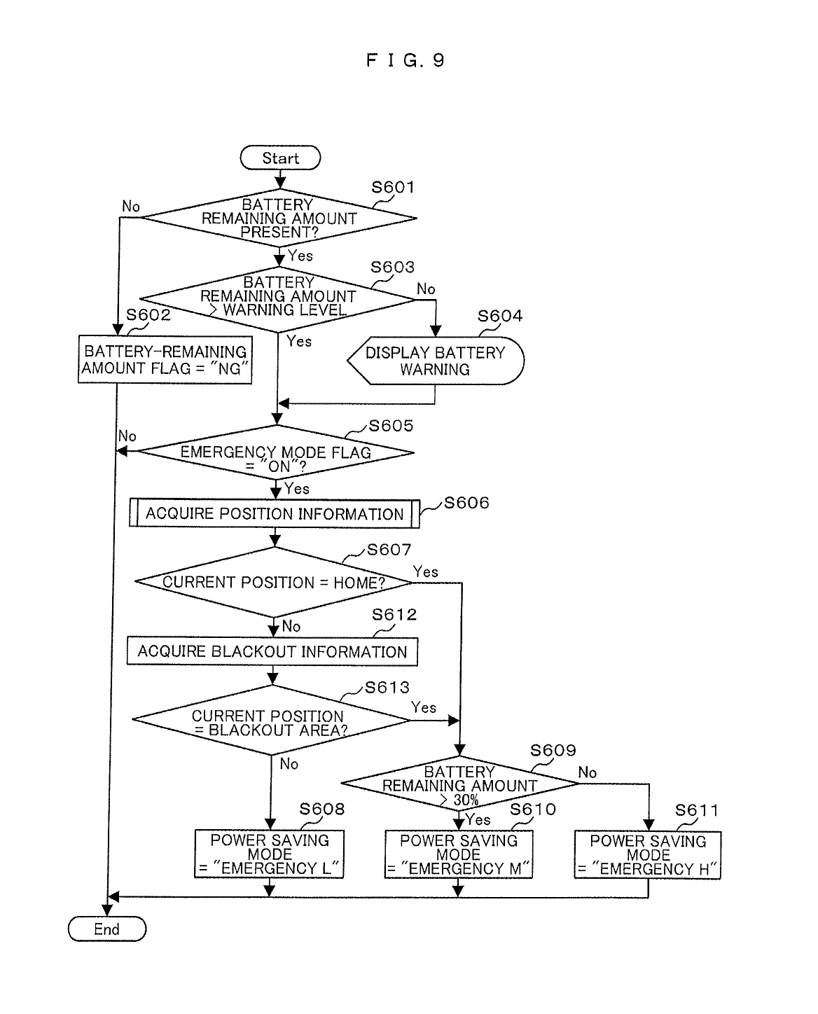

FIG. 9 shows the third example of the flowchart of the battery remaining amount confirming process S201.

The process in FIG. 9 is different from the battery remaining amount confirming process in FIG. 6 in that the processes S612 and S613 using the blackout information are added. The same processes as those in FIG. 6 are labeled with the same reference signs. Further, regarding portions of which the contents are the same as those in FIG. 6, those in FIG. 6 are incorporated and the description is omitted.

In FIG. 9, in a case where it has been determined that the current position is not at the user's home (No) in the branch process S607, the flow branches to S609. In a case where it has been determined that the current position is the user's home (Yes), connection with the external network 600 via the base station 400 or the wireless router 500 is achieved, so that information on an area where a blackout is occurring is acquired (S612). In the branch process S613, it is checked whether or not the current position is within the blackout area. In a case where the current position is not within the blackout area (No), the electric power saving mode is set to “emergency L” (S608) and the process is ended. In a case where the current position is within the blackout area (Yes), the flow branches to S609. In S609, it is checked whether or not the battery remaining amount is a predetermined value (30% in this example) or more. In a case where the battery remaining amount is the predetermined value or less (No), the electric power saving mode is set to “emergency H” (S611), each setting item is changed so that the electric power consumption is the minimum, and the process is ended. In a case where the battery remaining amount is the predetermined value or more (Yes), the electric power saving mode is set to “emergency M” (S610), and the process is ended.

By the above process, the setting in the electric power saving mode is changed in accordance with the positional information of the user's home stored as the user information, the current positional information, the blackout information, and the battery remaining amount when the emergency disaster report has been received.

By the above process, the electric power saving is enhanced when the current position is not at the user's home or the user's home is within the blackout area, and the electric power consumption is set to the minimum when the battery remaining amount is the predetermined value or less. Therefore, the operation time of the portable terminal device is extended.

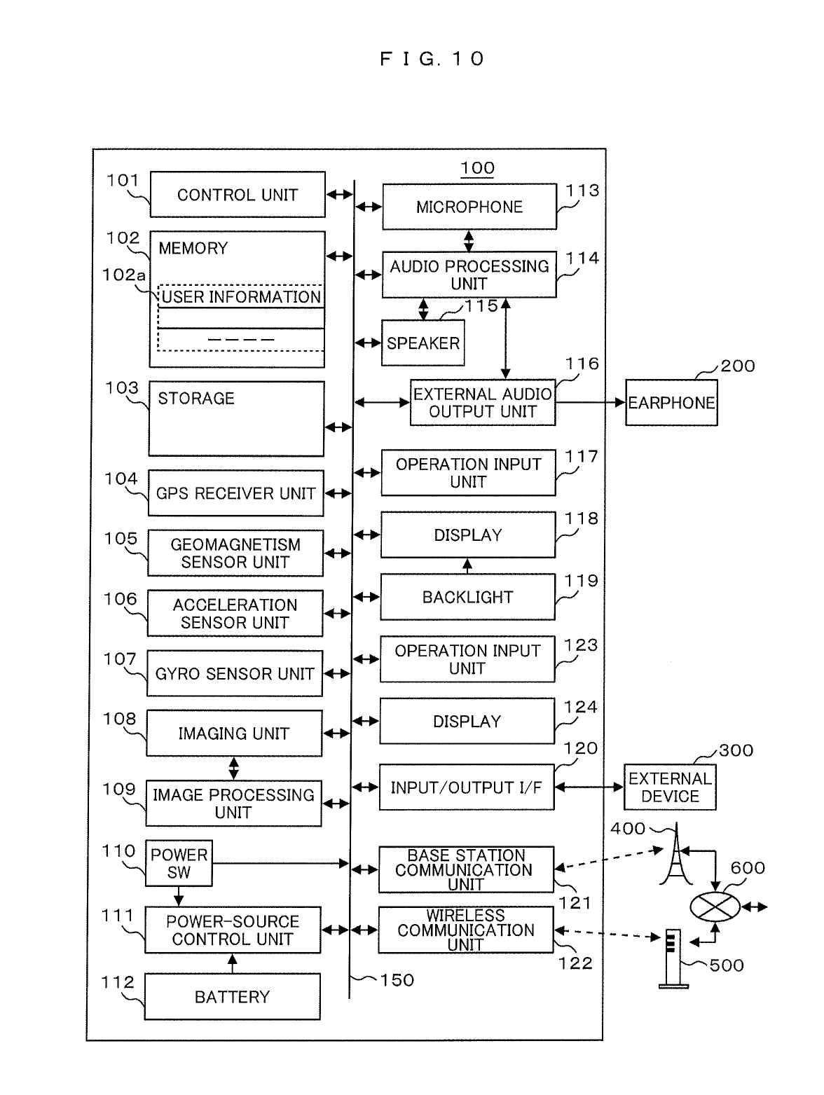

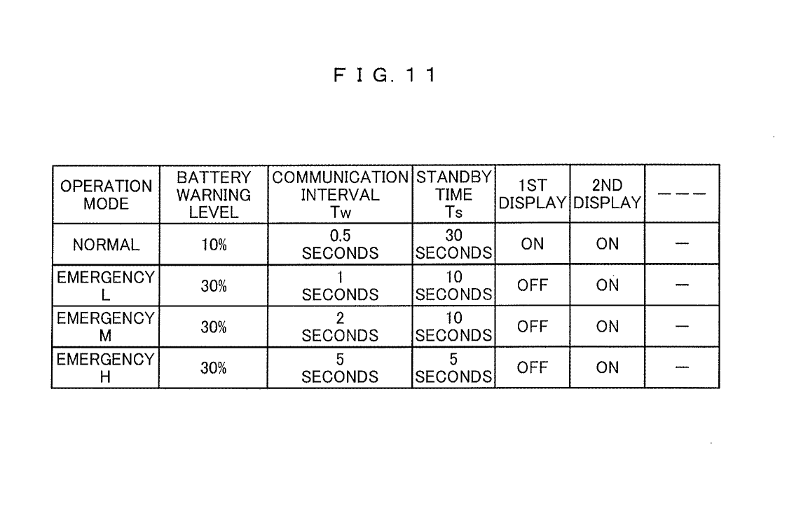

FIG. 10 is a block diagram showing the second configuration example of the portable terminal device 100. The same functional portions as those in the configuration example of FIG. 1 are labeled with the same reference signs. Further, regarding portions of which the contents are the same as those in FIG. 1, those in FIG. 1 are incorporated and the description is omitted here.

In this example, the second display 124 is added in the configuration example of FIG. 1. The display 124 has the second operation input unit 123 that is a touch pad type, on its display screen.

The second display 124 is a reflective liquid crystal or an electric paper, for example, and is not suitable for displaying a movie. However, the second display 124 can have reduced electric power consumption, as compared with the first display 118.

FIG. 11 shows an example of various items set in the electric power saving mode in the portable terminal device 100 shown in FIG. 10. When the emergency disaster report has been received, an operation of the first display 118 is turned off, and displaying is performed by the second display only. Thus, viewing e-mails, displaying a map in emergency evacuation and the like are performed with the second display having low electric power consumption, so that the electric power consumption of the portable terminal device can be reduced and the operation time is extended.

In the above examples, the electric power saving mode is switched in accordance with the current position and the battery remaining amount when the emergency disaster report has been received. However, this switching can be applied to a case where no emergency disaster report has been received. This can prevent the portable terminal device from being inoperative while the user is out for a long time, for example. Further, FIG. 8 provides the description on the assumption of the emergency disaster. However, even if not for an emergency disaster, it is apparent that the effect of guaranteeing the battery remaining amount for a long time during the blackout can be brought about by switching the electric power saving mode in accordance with the current position and the battery remaining amount when the blackout information provided by an electric power company or the like has been acquired, for example.

Although three levels of “emergency H”, “emergency M”, and “emergency L” are set as the electric power saving mode in emergency, the setting of the electric power saving mode is not limited thereto. For example, the electric power saving mode may be set to “emergency H” in a place other than the user's home or in a case where the user's home is within the blackout area, and be set to “emergency L” in other cases.

Further, the content of the emergency disaster report may be any information. For example, it may be an emergency earthquake report, an emergency lightning report, an emergency fire report, an emergency tsunami report, an emergency typhoon report, an emergency heavy rain report, an emergency river flood report, and an emergency eruption report.

Acquiring the blackout information can be achieved in various ways, for example, from information posted on a website of an electric power company, information sent by e-mail, and the like.

In the above examples, the setting of the electric power saving mode is performed based on the determination whether or not the current position is in the user's home. However, the setting is not limited thereto. The setting of the electric power saving mode may be performed based on determination of whether or not the current position is in a place registered in advance where the battery can be charged, for example, a school or an office.

Furthermore, as the content transmitted to a preset destination, information on the battery remaining amount may be transmitted in addition to the positional information, so that the destination is notified of the possibility of losing contact with the user because of battery run-out in the future.

The above-described examples are described in detail for intelligible description of the present invention, but are not intended to limit the present invention to include all the described components. Further, to a portion of the configuration of each example, an addition of another configuration and a replacement with another configuration can be performed. Also, a portion of the configuration of each component can be deleted. In addition, each of the above-described configurations, functions, processing units, processing means, and the like can be partly or entirely implemented by hardware by being designed by an integrated circuit, for example. Further, each of the aforementioned configurations, functions, and the like can be implemented by software by interpretation and execution of a program that achieve each function by a processor. Information such as a program, a table, and a file for achieving each function can be stored in the memory 102 or the storage 103.

Control lines and information lines that are considered as necessary for description are shown, but all control lines and all information lines in a product are not necessarily shown. It can be considered that almost all components are mutually connected actually.

### LIST OF REFERENCE SIGNS

100: portable terminal device, 101: control unit, 102: memory, 103: storage, 104; GPS receiver unit, 110: power switch, 111: power-source control unit, 112, battery, 117: operation input unit, 118: display, 119: backlight, 121: base station communication unit, 122: wireless communication unit, 123: operation input unit, 124: display, 400: base station, 500: wireless router, 600: external network

1. A portable terminal device having a function of receiving emergency disaster information or blackout information and notifying a user, comprising:
a receiver unit configured to receive the emergency disaster information or the blackout information;
a positional-information acquisition unit configured to acquire positional information of the portable terminal device;
a battery;
a power-source control unit configured to supply electric power supplied from the battery to a plurality of parts forming the portable terminal device; and
a control unit configured to control the power-source control unit to control electric power consumption of the portable terminal device,
wherein the control unit controls the power-source control unit based on the positional information acquired by the positional-information acquisition unit when the receiver unit has received the emergency disaster information or the blackout information.

2. The portable terminal device according to claim 1, further comprising a storage unit configured to store positional information in advance,
wherein the control unit controls the power-source control unit based on the positional information acquired by the positional-information acquisition unit and the positional information stored in the storage unit, in a case where information received by the receiver unit is the emergency disaster information.

3. The portable terminal device according to claim 2,
wherein the power-source control unit detects a battery remaining amount of the battery, and
the control unit controls the power-source control unit based on the battery remaining amount detected by the power-source control unit, in a case where the position acquired by the positional-information acquisition unit and the position stored in the storage unit are out of a predetermined range.

4. The portable terminal device according to claim 1, wherein the control unit controls the power-source control unit based on the positional information acquired by the positional-information acquisition unit and the blackout information acquired by the receiver unit, in a case where information received by the receiver unit is the blackout information.

5. The portable terminal device according to claim 2,
wherein the power-source control unit detects a battery remaining amount of the battery, and
when the receiver unit has further received the blackout information, the control unit controls the power-source control unit based on the battery remaining amount detected by the power-source control unit, in a case where the position acquired by the positional-information acquisition unit and the position stored in the storage unit are out of a predetermined range and the position acquired by the positional-information acquisition unit is within a blackout area based on the blackout information.

6. The portable terminal device according to claim 2,
wherein the storage unit further stores a plurality of warning levels for the battery remaining amount, and
the control unit changes setting of the warning level for the battery remaining amount of the portable terminal device based on the battery remaining amount of the battery detected by the power-source control unit and the warning levels stored in the storage unit in a case where the information received by the receiver unit is the emergency disaster information.

7. The portable terminal device according to claim 6, further comprising a display configured to display a warning of the battery remaining amount.

8. The portable terminal device according to claim 1, further comprising a first display having a backlight and a second display having no backlight,
wherein the control unit performs control to stop supply of the electric power to the first display when the receiver unit has received the emergency disaster information or the blackout information.
